(19) United States
(12) Patent Application Publication
(10) Pub. No.: US 2023/0332993 A1
(43) Pub. Date: Oct. 19, 2023

(54) METHODS AND PROCESS CONTROL FOR REAL TIME INERT MONITORING OF ACID COPPER ELECTRODEPOSITION SOLUTIONS

(71) Applicant: ECI TECHNOLOGY, INC., Totowa, NJ (US)

(72) Inventors: Eugene SHALYT, Washington Township, NJ (US); Aaron HABER, Flushing, NY (US); Chuannan BAI, Bridgewater, NJ (US)

(73) Assignee: ECI TECHNOLOGY, INC., Totowa, NJ (US)

(21) Appl. No.: 18/150,465

(22) Filed: Jan. 5, 2023

Related U.S. Application Data
(60) Provisional application No. 63/331,455, filed on Apr. 15, 2022.

(51) Int. Cl. G01N 9/36; G01N 9/24; C25D 1/00

(52) U.S. Cl. CPC G01N 9/36; G01N 9/24; C25D 1/00; G01N 2223/509

(57) ABSTRACT

Techniques including methods and apparatuses for inert real-time measurement and monitoring of metal and acid concentrations in a processing solution are provided. Methods include performing an analytical method (e.g., spectral measurements) of the processing solution to determine a metal concentration and performing another analytical method (e.g., density measurements) of the processing solution to determine an acid concentration with compensation of raw results based on the determined metal concentration. The determination of the acid concentration can also include compensation of raw results based on another analytical method (e.g., temperature measurements) of the processing solution. The analytical methods can be performed in any order or in parallel. Both metal and acid concentrations in the processing solution can therefore be inertly and continuously measured and monitored in real time.

### CROSS-REFERENCE TO RELATED APPLICATIONS

This application claims the benefit, under 35 U.S.C. § 119(e), of U.S. Provisional Patent Application No. 63/331,455, filed Apr. 15, 2022, which is incorporated herein by reference.

### FIELD

The present disclosure relates to analysis and process control for metallization of processing solutions, for example, semiconductor processing solutions, and more particularly to techniques for real time inert measurement and monitoring of acid and metal concentrations in such processing solutions.

### BACKGROUND

Processing solutions are used in several industries, including the semiconductor industry, to produce products with desired properties. Such processing solutions can include, for example, a blend of metals and acids among other components. An exemplary electrolyte can include copper sulfate, sulfuric acid, hydrochloric acid, one or more organic additives, and water. The same electrolyte can be used for processing a relatively large quantity of products, for example, semiconductor wafers or interconnects for semiconductors during the back-end-of-line (BEOL) stage of manufacturing.

In order to ensure effective process control, the solution composition can be analyzed and corrective action can be performed in order to maintain a predetermined concentration of the chemical components in the solution, for example, by chemical addition or partial substitution of an older electrode with a fresh electrode. The monitoring of processing solutions and replenishing of the same as needed can provide for improved process performance. Certain products can be used for process control of electrolytes and measure the solution components, with a frequency of from about every 5 minutes to about every 60 minutes. Electrolyte solutions can have relatively high concentrations of metals and acids (e.g., 160 g/L CuSO₄x5H₂O and 100 g/L H₂SO₄). As the semiconductor industry develops small feature sizes (e.g., N3, N5, N7, or N10 nodes), electrodeposition processes can become challenging as smaller concentrations of metals and acids are employed (e.g., 20 g/L CuSO₄x₅H₂O and 10 g/L H₂SO₄). Operating processes at such relatively low concentrations can accelerate concentration drifts. Therefore, it can take less time for the process solution to drift out of a predetermined control range. As such, there is a need for continuous selective monitoring of both acid and metal concentrations in processing solutions.

Metal concentrations can be continuously monitored in solution in real time with inert hardware, for example, through visible near-infrared (Vis-NIR) spectroscopy. However, certain approaches to measuring acid concentration in solution (e.g., sulfuric acid in an acid copper solution) have certain disadvantages and do not allow for real time inert monitoring of acid concentration. Examples include acid-base titration, near-infrared (NIR)-spectroscopy, and electrochemical methods. Specifically, acid-base titration as the solution for monitoring acid concentration is not a real-time method. Further, NIR-spectroscopy can provide measurements of acid concentration for processes with relatively high concentrations of acid and metals (e.g., about 100 g/L H₂SO₄), but does not necessarily have sufficient sensitivity for relatively low acid concentrations (e.g., about 10 g/L H₂SO₄). Electrochemical methods for measuring acid concentration are not inert, as electrodes brought into contact with the solution and sample should be disposed of after measurement. While periodic measurement can be performed, for example, about every 5 minutes, continuous measurement of the solution via electrochemical methods can waste solution.

Certain methods provide for the combination of a metal and acid analyzer, in which the acid concentration can be measured by density of the solution having the acid (e.g., sulfuric acid) as a dominant component. As such, the measurement of the acid concentration can be used as a direct function of density without any compensation for metal concentration. However, certain such methods do not provide acceptable performance as they do not consider the comparable effects of metals (e.g., in the form of metal salts) and acids on density measurements.

### SUMMARY

It is thus desirable to provide processes and apparatuses for continuous real-time inert measurement and monitoring of acid and metal concentrations in processing solutions. The present disclosure addresses these and other needs by providing techniques for continuous real-time inert measurement and monitoring of acid (e.g., sulfuric acid, H₂SO₄) and metal (e.g., copper, Cu) concentrations in processing solutions (e.g., semiconductor processing solutions).

Exemplary techniques include the real-time inert measurement of a metal concentration by an analytical method and performing another analytical method on the same solution to determine a real-time inert measurement of acid concentration with compensation of raw results based on the metal concentration. In certain aspects, determination of the acid concentration can include compensation of raw results based on a temperature of the processing solution. Thus, selective monitoring of acid concentration in a multi-component solution blend can be achieved by using a non-selective analytical signal and further providing selectivity by compensation for the metal concentration in solution and temperature variability. In certain aspects, such techniques can also be utilized in a stand-alone analyzer.

The purpose and advantages of the disclosed subject matter will be set forth in and are apparent from the description as follows, as well as will be learned by practice of the disclosed subject matter. Additional advantages of the disclosed subject matter will be realized and attained by the devices particularly pointed out in the written description and claims thereof, as well as from the appended drawings.

In certain embodiments, the disclosed subject matter provides methods for determining a concentration of an acid in a processing solution including one or more acids and one or more metals. An exemplary method includes performing an analytical method of the processing solution to provide an analytical measurement, and determining a concentration of the one or more metals from the analytical measurement. The method further includes measuring a density of the processing solution and determining the concentration of the acid from the measured density of the processing solution and the concentration of the one or more metals.

In certain embodiments, the analytical method can include measuring an optical property of the processing solution. In certain embodiments, the optical property of the processing solution can be measured by UV-Vis-spectroscopy. In certain embodiments, the metals can include copper. In certain embodiments, the acids can include sulfuric acid. In certain embodiments, the processing solution can be an electrodeposition solution.

In certain embodiments, the method can further include measuring a temperature of the processing solution. In certain embodiments, the concentration of the acid can be further determined from the temperature of the processing solution.

In certain embodiments, performing the analytical method and measuring the density of the processing solution can be performed in parallel. In certain embodiments, performing the analytical method, measuring the density of the processing solution, and measuring the temperature of the processing solution can be performed in parallel.

The disclosed subject matter further provides an apparatus for determining a concentration of an acid in a processing solution including one or more acids and one or more metals. In an exemplary embodiment, an apparatus includes a measurement module operatively connected to one or more sensors and adapted to receive a process sample. The process sample includes at least a portion of the processing solution. The sensors are adapted to receive at least a portion of the process sample, and are operative to perform one or more analytical methods. In certain embodiments, the sensors can be a spectral sensor and/or a density sensor. In certain embodiments, the sensors can further include a temperature sensor.

In certain embodiments, the spectral sensor can include a chemically inert material. In certain embodiments, the density sensor can include a chemically inert material. In certain embodiments, the processing solution can include copper and sulfuric acid.

### BRIEF DESCRIPTION OF THE DRAWINGS

The following figures are included to illustrate certain aspects of the present disclose and should not be viewed as exclusive embodiments. The subject matter disclosed is capable of considerable modifications, alterations, combinations, and equivalents in form and function, without departing from the scope of the disclosure.

FIG. 1 schematically illustrates an exemplary apparatus of the present disclosure;

FIG. 2 illustrates results of Vis-NIR spectroscopy measurements in absorbance versus wavelength (nm) of acid copper electrodeposition solution samples to quantitate copper (Cu) concentration in accordance with Example 1;

FIG. 3 illustrates a calibration curve of copper (Cu) (g/L) versus absorbance (at 750 nm) of acid copper electrodeposition solution samples in accordance with Example 1; and

FIG. 4 illustrates results of density (g/L) versus temperature (° C.) of acid copper electrodeposition solution samples in accordance with Example 1.

### DETAILED DESCRIPTION

The present disclosure provides techniques for real-time inert measurement and monitoring of metal and acid concentrations in processing solutions such as semiconductor processing solutions. In certain embodiments, the present disclosure provides for combining an analytical method for determining the metal concentration in solution (e.g., spectroscopy measurements) with another analytical method of the solution (e.g., density measurements) in order to determine the real-time concentration of both acid and metal components the solution. The acid concentration can be determined by compensating the raw results of the separate analytical method (e.g., density measurements) with the metal concentration derived from the analytical method (e.g., spectroscopy measurements) utilized for determining the same. In certain aspects, the acid concentration can be determined by compensating the raw results of analytical methods with temperature variability. The analytical methods can be performed in any order or in parallel. In certain embodiments, the analytical methods are performed in parallel. Accordingly, both the metal concentration and acid concentration of a processing solution can advantageously be continuously and inertly measured and monitored in real-time.

The terms used in this specification generally have their ordinary meanings in the art, within the context of this disclosure and in the specific context where each term is used. Certain terms are discussed below, or elsewhere in the specification, to provide additional guidance to the practitioner in describing the compositions and methods of the present disclosure and how to make and use them.

For purposes of interpreting this specification, the following definitions will apply and whenever appropriate, terms used in the singular will also include the plural and vice versa. In the event that any definition set forth below conflicts with any document incorporated herein by reference, the definition set forth below shall control.

As used herein, the use of the word “a” or “an” when used in conjunction with the term “comprising” in the claims and/or the specification can mean “one,” but it is also consistent with the meaning of “one or more,” “at least one,” and “one or more than one.”

As used herein, the term “about” or “approximately” means within an acceptable error range for the particular value as determined by one of ordinary skill in the art, which will depend in part on how the value is measured or determined, i.e., the limitations of the measurement system. For example, “about” can mean within 3 or more than 3 standard deviations, per the practice in the art. Alternatively, “about” can mean a range of up to 20%, preferably up to 10%, more preferably up to 5%, and more preferably still up to 1% of a given value.

As used herein, the term “accurate” or “accurately” refers to, for example, a measurement or determination that is relatively close to or near an existing or true value, standard, or known measurement or value.

The terms “comprise(s),” “include(s),” “having,” “has,” “can,” “contain(s),” and variants thereof, as used herein, are intended to be open-ended transitional phrases, terms or words that do not preclude additional acts or structures. The present disclosure also contemplates other embodiments “comprising,” “consisting of” and “consisting essentially of,” the embodiments or elements presented herein, whether explicitly set forth or not.

As used herein, the terms “coupled” or “operatively coupled” refers to one or more components being combined with each other and as used herein is intended to mean either an indirect or a direct connection. Thus, if one device couples to a second device, that connection may be through a direct connection, or through an indirect mechanical or other connection via other devices or connections.

As used herein, the term “selective” or “selectively” refers to, for example, the monitoring, measurement or determination of a characteristic of a specific or particular component.

As used herein, the term “real time” or “real-time” refers to, for example, as happening at a rate that is substantially the same as the real current process.

The methods of the present disclosure can be applied to various types of solutions including processing solutions. In certain embodiments, the solution can be a semiconductor processing solution. For example and not by way of limitation, the solution can be an acid copper electrodeposition solution.

In certain embodiments, the solution can include one or more metals. A person skilled in the art will appreciate a wide combination of metals are suitable for use with the present disclosure. In certain embodiments, the solution can include copper (Cu). In certain embodiments, the solution can include one or more metal salts. A person skilled in the art will appreciate a wide combination of metal salts are suitable for use with the present disclosure. For example, and not by way of limitation, the solution can include copper sulfate (CuSO4). In certain embodiments, the solution can include one or more acids. A person skilled in the art will appreciate a wide combination of acids are suitable for use with the present disclosure. In certain embodiments, the processing solution can include sulfuric acid (H₂SO₄), hydrochloric acid (HCl), or combinations thereof. In certain aspects, the processing solution can include a blend of one or more metals, for example, as one or more metal salts, and one or more acids. A person skilled in the art will appreciate a wide variety of combinations of one or more metals and one or more acids are suitable for use with the present disclosure. In certain embodiments, the processing solution can include copper (Cu), e.g., as copper sulfate (CuSO₄), and sulfuric acid (H₂SO₄). In certain embodiments, the processing solution can include copper sulfate (CuSO₄) and sulfuric acid (H₂SO₄). In certain aspects, the processing solution can include one or more organic additives. In certain embodiments, the processing solution can include water.

Methods of the present disclosure provide multiple analytical methods and measurements of solutions, for example, in order to inertly measure and monitor acid concentration, metal concentration, or combinations thereof continuously in real-time. The concentration of a metal can be inertly measured and monitored in a solution by performing an analytical method of the solution. In certain embodiments, the analytical method can include measuring an optical property of the solution. For example, and not by way of limitation, the analytical method can include measuring an absorbance of the solution, a transmittance of the solution, or a combination thereof (e.g., through Vis-NIR absorption spectroscopy). In certain aspects, an optical property of the processing solution can be measured by a spectral sensor. The spectral sensor can be operable to scan and detect a wavelength (nm) of the solution. In certain embodiments, the spectral sensor can include one or more chemically inert wetted materials (e.g., quartz or sapphire). A person skilled in the art will appreciate a wide variety of methods for measuring optical properties (e.g., absorbance and/or transmittance) are suitable for use with the present disclosure.

In such embodiments, measurements of optical properties, e.g., an absorbance, of the solution can provide a metal concentration. In certain aspects, the metal concentration can be calculated using the Beer-Lambert Law (Equation I) disclosed herein in the Examples. To provide real-time inert monitoring of one or more acids in the solution, another analytical method can be conducted. In certain embodiments, the analytical method can include measuring a density of the solution, for example, with a density sensor (e.g., a densitometer). The density sensor can be operative to measure a density of the solution. In certain embodiments, the density sensor can include one or more chemically inert wetted materials, for example, polytetrafluoroethylene (e.g., PTFE or Teflon) or glass. A person skilled in the art will appreciate a wide variety of methods for measuring density are suitable for use with the present disclosure. In certain embodiments, the measurements of density of the solution can provide an acid concentration. For example, and not by way of limitation, the acid concentration can be calculated using Equation II disclosed herein in the Examples. The calculation can include the correction for the metal concentration as determined from analytical methods such as spectral properties of the solution.

In certain embodiments, the temperature of the processing solution can be measured. For example, in certain embodiments, the temperature of the processing solution can be measured by a temperature sensor. A person skilled in the art will appreciate a wide variety of methods for measuring temperature are suitable for use with the present disclosure. In certain embodiments, measurements of density can be compensated for by the temperature of the solution. As solution density can be dependent on temperature, the acid concentration in solution can be compensated with the temperature of the solution, for example, by using Equations III or IV provided in the Examples.

Accordingly, the metal concentration and the acid concentration of a solution, such as a processing solution, can be measured and monitored inertly in real-time by accurate methods. In certain aspects, these measurements can be used to selectively determine an acid concentration of a solution. In certain embodiments, an analytical method, for example, spectral property measurements of the processing solution (e.g., absorbance and/or transmittance), can be combined with another analytical method, for example, density measurements of the processing solution. From such measurements, the metal concentration and the acid concentration of the solution can be determined. Further, the acid concentration can be determined by compensating the raw results of the analytical methods utilized to determine the same with the determined metal concentration and temperature variability. Thus, an acid concentration in solution can be selectively measured and monitored by using a non-selective analytical signal (e.g., density measurements) and providing selectivity by compensation for the metal concentration in solution and temperature variability.

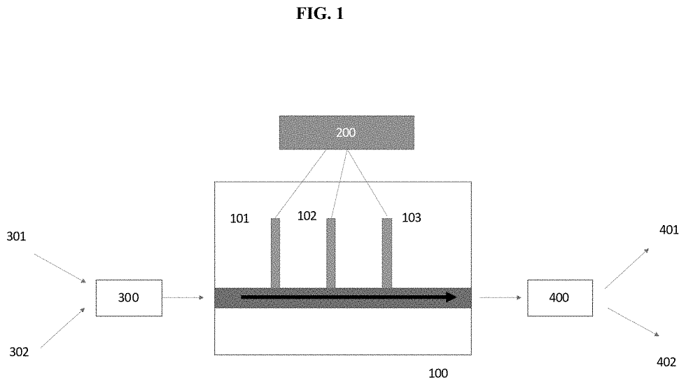

FIG. 1 schematically illustrates an exemplary apparatus of the present disclosure. In certain aspects, the exemplary apparatus can relate to measuring and monitoring acid and metal concentrations in solutions such as processing solutions. The apparatus can include a measurement module 100. The measurement module 100 can include one or more sensors, for example, operative to perform one or more analytical methods. In certain embodiments, the one or more analytical methods can include measuring a wavelength (e.g., an absorbance) of the solution, measuring a density of the solution, measuring a temperature of the solution, or combinations thereof. In certain embodiments, the one or more sensors can include a spectral sensor 101, a density sensor 102, a temperature sensor 103, or combinations thereof. The spectral sensor 101 can be operative to perform a spectral scan and detect a wavelength of the solution. In certain embodiments, the spectral sensor 101 can include one or more chemically inert wetted materials, for example, quartz or sapphire. The density sensor 102 can be operative to measure a density of the solution. In certain embodiments, the density sensor 102 can include one or more chemically inert wetted materials, for example, polytetrafluoroethylene (e.g., PTFE or Teflon) or glass. The temperature sensor 103 can be operative to measure a temperature of the solution. In certain embodiments, the one or more sensors can be individual or integrated. The one or more sensors can be positioned in series in any order, sequentially or in parallel. In certain embodiments, the sensors can include the spectral sensor 101, the density sensor 102, and the temperature sensor 103, positioned sequentially. In certain aspects, valves or manifolds of the apparatus, for example, for sensor installation can include a chemically inert material. For example, and not by way of limitation, in certain embodiments, the valves or manifold can include a polytetrafluoroethylene (e.g., PTFE or Teflon) wetted material.

In certain embodiments, the apparatus can further include a measurement module 200. The measurement module 200 can be operatively connected to one or more of the one or more sensors 101, 102 and 103. In certain embodiments, the measurement module 200 can be operatively connected to each of the spectral sensor 101, the density sensor 102, and the temperature sensor 103. In certain embodiments, the one or more sensors 101, 102 and 103 can be operatively connected to the measurement module 200 by fiberoptics, electrical cables, or a combination thereof. In certain aspects, the measurement module 200 can include electronics, optical elements, etc.

A process sample 301 can be introduced to the apparatus. In certain embodiments, the process sample 301 can include one or more metals (e.g., one or more metal salts), one or more acids, or combinations thereof In certain embodiments, the process sample 301 can flow through the measurement module 100 and be measured by the one or more sensors 101, 102 and 103. In certain embodiments, a standard solution 302 (or reference solution or calibration solution) can be introduced to the apparatus. In certain aspects, the standard solution 302 can include a known concentration of one or more acids, one or more metals (e.g., one or more metal salts), or a combination thereof In certain aspects, the standard solution 302 can flow through the measurement module 100 and be measured by the one or more sensors 101, 102 and 103. Optionally, the apparatus can include a selector valve 300. In certain embodiments, the selector valve 300 can be positioned at the input. In certain embodiments, the selector valve 300 can be operative to alternate between the process sample 301 and the standard solution 302.

After analytical measurements of the solution (e.g., the process sample 301 or the standard sample 302) are completed, the solution can be flowed to return to the process 401 or discarded as waste 402. Optionally, the apparatus can include a selection valve 400, for example, operative to divert the sample to either process 401 or waste 402.

### EXAMPLE

The presently disclosed subject matter will be better understood by reference to the following Example. The following Example is merely illustrative of the presently disclosed subject matter and should not be considered as limiting the scope of the subject matter in any way.

### Example 1

This Example provides for continuous inert real-time measurement and monitoring of acid and metal concentrations in an acid copper electrodeposition solution. The continuous inert real-time measurement and monitoring of a metal concentration (i.e., of copper sulfate) was achieved by performing an analytical method, i.e., Vis-NIR spectroscopy. The continuous inert real-time measurement and monitoring of an acid concentration (i.e., of sulfuric acid) was achieved by performing an analytical method, i.e., density measurement and compensating the same with the measured metal concentration and temperature variability.

Analytical equipment can develop drift over time. In order to compensate for such drift, samples with known compositions can be periodically measured. The offset can be automatically reset based on the potential gap between measured and expected value of a sample (e.g., New Offset=Old Offset+Expected Concentration−Measured Concentration). This approach can be performed for either a metal concentration (e.g., copper), an acid concentration (e.g., sulfuric acid), or both. A sample with known composition can be a virgin make-up solution (VMS) including copper sulfate (CuSO₄), sulfuric acid (H₂SO₄), and hydrochloric acid at predetermined target concentrations. The solution is available in the electrodeposition tool as a raw material with certified composition. Other types of samples with known composition can be used.

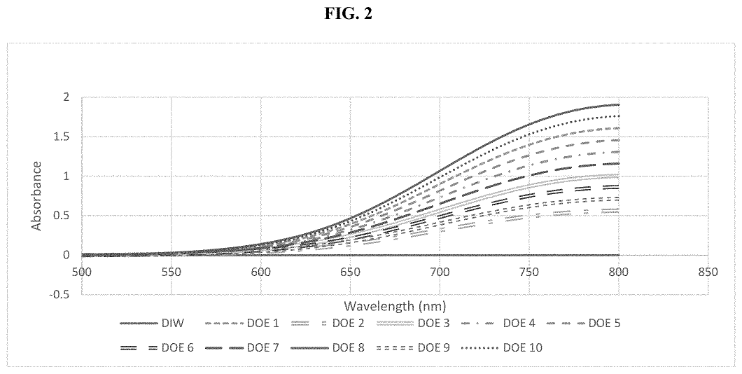

Vis-NIR absorption spectroscopy was performed on ten (10) (DOE1-DOE10) samples of acid copper electrodeposition solutions each having varying concentrations of copper sulfate and sulfuric acid. The Vis-NIR absorption spectroscopy had chemically inert wetted materials (e.g., quartz or sapphire). The metal concentration measurement for copper (Cu) was performed using Vis-NIR absorption spectroscopy. Copper (Cu) has a relatively broad peak, i.e., in the range of 500-1,000 nm. Any individual wavelength or their combination was used. A flow cell of characterized pathlength was illuminated with a light source that outputted light into a segment within the 500-1,000 nm range. The intensity of the light after the flow cell was monitored at either an individual wavelength or calibration of wavelength was measured. The data was collected with a Vis-NIR absorption spectrophotometer (Agilent Cary) and provided in FIG. 2.

The Beer-Lambert Law (Equation I) was used to calculate the concentration of copper (Cu) as follows.

A=log (Io/I)=e*c*d (I)
A—absorbance
Io—intensity of light in the absence of copper (Cu)
I—intensity of light after interaction with a copper (Cu) sample
e—molecular extinction coefficient (dependent on wavelength)
c—copper (Cu) concentration
d—optical pathlength

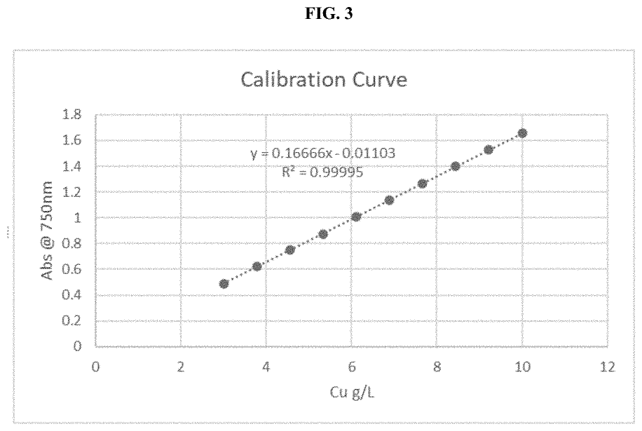

A calibration curve of absorbency versus the copper (Cu) concentration (g/L) is provided in FIG. 3.

The results demonstrating the accuracy between the calculated and actual copper (Cu) concentration is provided in Table 1 below. Accuracy (i.e., absolute analytical error)<0.033 g/L was demonstrated.

TABLE 1

| | Cu | Absorbance | Measured Cu | Accuracy |
|---|---|---|---|---|
| Sample | (g/L) | (at 750 nm) | (g/L) | (g/L) |
| Sample 1 | 8.44 | 1.397186518 | 8.45 | 0.010 |
| (DOE 1) | | | | |
| Sample 2 | 3 | 0.490595996 | 3.01 | 0.010 |
| (DOE 2) | | | | |
| Sample 3 | 5.33 | 0.871707737 | 5.30 | −0.033 |
| (DOE 3) | | | | |
| Sample 4 | 6.89 | 1.135486484 | 6.88 | −0.011 |
| (DOE 4) | | | | |
| Sample 5 | 7.67 | 1.264282823 | 7.65 | −0.018 |
| (DOE 5) | | | | |
| Sample 6 | 4.56 | 0.75053072 | 4.57 | 0.010 |
| (DOE 6) | | | | |
| Sample 7 | 6.11 | 1.008155346 | 6.12 | 0.005 |
| (DOE 7) | | | | |
| Sample 8 | 10 | 1.655110836 | 10.00 | −0.003 |
| (DOE 8) | | | | |
| Sample 9 | 3.78 | 0.620568574 | 3.79 | 0.010 |
| (DOE 9) | | | | |
| Sample 10 | 9.22 | 1.529229641 | 9.24 | 0.022 |
| (DOE 10) | | | | |

A measurement of the density of samples 1-10 (i.e., a blend of sulfuric acid and copper sulfate) were performed using an Anton-Paar densitometer. The density sensor had chemically inert wetted materials (i.e., polytetrafluoroethylene (PTFE or Teflon)) and glass). Teflon and glass). The measured sulfuric acid concentration was calculated using Equation II below, which was corrected with the copper (Cu) concentration.

Measured Sulfuric Acid=Offset+Cu Coefficient×[Cu Result]+Density Coefficient×[Density Measurement] (II)

The coefficients for Equation II are provided in Table 2 below.

TABLE 2

| | Coefficient |
|---|---|
| Cu | −4.16546 |
| Density | 1646.44 |
| Offset | −1644.85 |

The results demonstrating the accuracy between the measured (corrected for copper (Cu) concentration)) and actual sulfuric acid (H₂SO₄) concentration is provided in Table 3 below. Accuracy (i.e., absolute analytical error)<0.23 g/L was demonstrated.

TABLE 3

| | | | | | Measured | |
|---|---|---|---|---|---|---|
| | | | | Sulfuric | Sulfuric | |
| | Density | Temp | Cu | Acid | (g/L) (Cu | Accuracy |
| Sample | (g/mL) | (° C.) | (g/L) | (g/L) | corrected) | (g/L) |
| Sample 1 | 1.0265 | 20.5 | 8.44 | 10.22 | 10.07 | −0.15 |
| (DOE 1) | | | | | | |
| Sample 2 | 1.014 | 20.2 | 3 | 12 | 12.15 | 0.15 |
| (DOE 2) | | | | | | |
| Sample 3 | 1.0184 | 20.2 | 5.33 | 9.78 | 9.69 | −0.09 |
| (DOE 3) | | | | | | |
| Sample 4 | 1.023 | 20.3 | 6.89 | 10.67 | 10.76 | 0.09 |
| (DOE 4) | | | | | | |
| Sample 5 | 1.0238 | 20.5 | 7.67 | 8.89 | 8.83 | −0.06 |
| (DOE 5) | | | | | | |
| Sample 6 | 1.0163 | 20.2 | 4.56 | 9.33 | 9.44 | 0.11 |
| (DOE 6) | | | | | | |
| Sample 7 | 1.0194 | 20.2 | 6.11 | 8 | 8.08 | 0.08 |
| (DOE 7) | | | | | | |
| Sample 8 | 1.0295 | 20.2 | 10 | 8.44 | 8.51 | 0.07 |
| (DOE 8) | | | | | | |
| Sample 9 | 1.0152 | 20.4 | 3.78 | 11.11 | 10.88 | −0.23 |
| (DOE 9) | | | | | | |
| Sample 10 | 1.0294 | 20.8 | 9.22 | 11.56 | 11.59 | 0.03 |
| (DOE 10) | | | | | | |

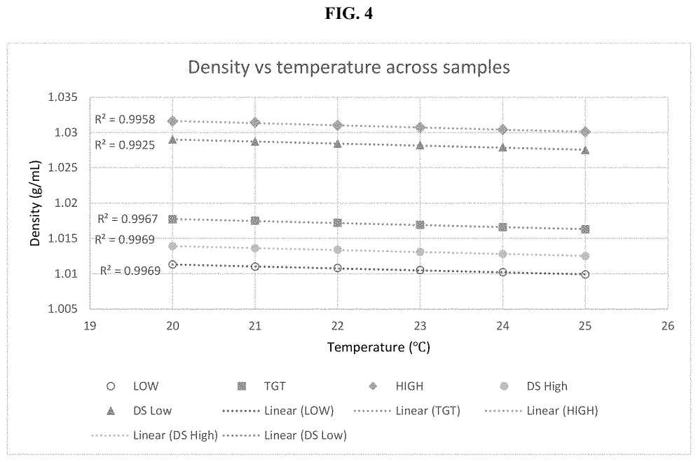

As density is temperature dependent, the results were compensated for specific temperature of each sample. The results are provided in FIG. 4 and Table 4 below. A near constant temperature slope was observed.

TABLE 4

| | | | Density | Density | Density | Density | Density | Density | |
|---|---|---|---|---|---|---|---|---|---|
| | Cu | H₂SO₄ | (g/mL) | (g/mL) | (g/mL) | (g/mL) | (g/mL) | (g/mL) | Temp |
| Sample | (g/L) | (g/L) | (20° C.) | (21° C.) | (22° C.) | (23° C.) | (24° C.) | (25° C.) | Slope |
| LOW | 3 | 8 | 1.0113 | 1.0110 | 1.0108 | 1.0105 | 1.0102 | 1.0099 | −0.000277 |
| TGT | 5 | 10 | 1.0177 | 1.0175 | 1.0172 | 1.0169 | 1.0166 | 1.0163 | −0.000286 |
| HIGH | 10 | 12 | 1.0316 | 1.0314 | 1.0310 | 1.0307 | 1.0304 | 1.0301 | −0.000309 |
| DS High | 3 | 12 | 1.0139 | 1.0136 | 1.0134 | 1.0131 | 1.0128 | 1.0125 | −0.000277 |
| DS Low | 10 | 8 | 1.0290 | 1.0287 | 1.0284 | 1.0282 | 1.0279 | 1.0275 | −0.000289 |

Temperature compensation was achieved by Equation III below.

[H₂SO₄]=Offset+Temp.Coefficient×[Temperature]+Cu Coefficient×[Cu]+Density Slope×[Density] (III)

The coefficients for Equation III are provided in Tables 5A and 5B.

TABLE 5A

| Density Slope | Temp Corr Coefficient | Cu Corr Coefficient | Offset |
|---|---|---|---|
| 1540.851 | 0.442885 | −3.8843812 | −1547.56 |

TABLE 5B

| Density Slope | Temp Slope | Cu Slope | Offset |
|---|---|---|---|
| 1540.851 | 0.442885 | −3.88438 | −1547.56 |

Data following temperature compensation is provided in Table 7 below.

TABLE 7

| | | | Measured H₂SO₄ | | | | | |
|---|---|---|---|---|---|---|---|---|
| | | | (g/L) (at certain temperature) | | | | | |
| | Cu | H₂SO₄ | 20° | 21° | 22° | 23° | 24° | 25° |
| Sample | (g/L) | (g/L) | C. | C. | C. | C. | C. | C. |
| LOW | 3 | 8 | 7.91 | 7.89 | 8.03 | 8.01 | 7.99 | 7.97 |
| TGT | 5 | 10 | 10.00 | 10.14 | 10.12 | 10.10 | 10.08 | 10.06 |
| HIGH | 10 | 12 | 12.00 | 12.14 | 11.96 | 11.94 | 11.92 | 11.90 |
| DS High | 3 | 12 | 11.92 | 11.90 | 12.03 | 12.01 | 12.00 | 11.98 |
| DS Low | 10 | 8 | 7.99 | 7.98 | 7.96 | 8.09 | 8.07 | 7.90 |

The results demonstrating the accuracy between the measured sulfuric acid (H₂SO₄) concentration with temperature compensation and actual sulfuric acid (H₂SO₄) concentration is provided in Table 8 below. Accuracy (i.e., absolute analytical error)<0.14 g/L was demonstrated.

TABLE 8

| | g/L |
|---|---|
| Avg abs error | 0.06 |
| Max error | 0.14 |

Other temperature coefficient equations can be used, for example, Equation IV provided below.

ρ1=ρ0/(1+β(t1−t0)) (IV)
β—volumetric temperature coefficient
t₁—measured temperature
t₀—reference temperature
ρ₁—measured density
ρ₀—density at reference temperature

The description herein merely illustrates the principles of the disclosed subject matter. Various modifications and alterations to the described embodiments will be apparent to those skilled in the art in view of the teachings herein. Accordingly, the disclosure herein is intended to be illustrative, but not limiting, of the scope of the disclosed subject matter. Moreover, the principles of the disclosed subject matter can be implemented in various configurations and are not intended to be limited in any way to the specific embodiments presented herein.

In addition to the various embodiments depicted and claimed, the disclosed subject matter is also directed to other embodiments having other combinations of the features disclosed and claimed herein. As such, the particular features presented herein can be combined with each other in other manners within the scope of the disclosed subject matter such that the disclosed subject matter includes any suitable combination of the features disclosed herein. The foregoing description of specific embodiments of the disclosed subject matter has been presented for purposes of illustration and description. It is not intended to be exhaustive or to limit the disclosed subject matter to those embodiments disclosed.

It will be apparent to those skilled in the art that various modifications and variations can be made in the systems and methods of the disclosed subject matter without departing from the spirit or scope of the disclosed subject matter. Thus, it is intended that the disclosed subject matter include modifications and variations that are within the scope of the appended claims and their equivalents.

What is claimed is:

1. A method for determining a concentration of an acid in a processing solution including one or more acids and one or more metals, comprising:
performing an analytical method of the processing solution to provide an analytical measurement, and determining a concentration of the one or more metals from the analytical measurement;
measuring a density of the processing solution; and
determining the concentration of the acid from the measured density of the processing solution and the concentration of the one or more metals.

2. The method of claim 1, wherein the analytical method comprises measuring an optical property of the processing solution.

3. The method of claim 2, wherein the optical property of the processing solution is measured by UV-Vis-spectroscopy.

4. The method of claim 2, wherein the method comprises measuring a transmittance of the processing solution, measuring an absorbance of the processing solution, or a combination thereof.

5. The method of claim 1, wherein the one or more metals comprises copper.

6. The method of claim 1, wherein the one or more acids comprises sulfuric acid.

7. The method of claim 1, wherein the processing solution is an electrodeposition solution.

8. The method of claim 1, wherein the method further comprises measuring a temperature of the processing solution.

9. The method of claim 8, wherein the concentration of the acid is further determined from the temperature of the processing solution.

10. The method of claim 1, wherein performing the analytical method and measuring the density of the processing solution are performed in parallel.

11. The method of claim 8, wherein performing the analytical method, measuring the density of the processing solution, and measuring the temperature of the processing solution are performed in parallel.

12. An apparatus for determining a concentration of an acid in a processing solution including one or more acids and one or more metals, comprising:
a measurement module operatively connected to one or more sensors and adapted to receive a process sample;
wherein the process sample comprises at least a portion of the processing solution,
wherein each of the one or more sensors are adapted to receive at least a portion of the process sample, and are operative to perform one or more analytical methods, and
wherein the one or more sensors comprises a spectral sensor, a density sensor, or combinations thereof.

13. The apparatus of claim 12, wherein the spectral sensor comprises a chemically inert material.

14. The apparatus of claim 12, wherein the density sensor comprises a chemically inert material.

15. The apparatus of claim 12, wherein the processing solution comprises copper and sulfuric acid.

16. The apparatus of claim 12, wherein the one or more sensors further comprises a temperature sensor.
